(19) United States
(12) Patent Application Publication
(10) Pub. No.: US 2023/0347911 A1
(43) Pub. Date: Nov. 2, 2023

(54) TRUCK LOAD IDENTIFICATION METHOD, ELECTRONIC DEVICE AND STORAGE MEDIUM

(71) Applicant: ZHEJIANG DAHUA TECHNOLOGY CO., LTD., Hangzhow (CN)

(72) Inventors: Zhihui LIU, Hangzhou (CN); Yaonong WANG, Hangzhou (CN); Yanxun YU, Hangzhou (CN); Zhijiang DU, Hangzhou (CN); Zhen ZHANG, Hangzhou (CN); Zhongwen XIAO, Hangzhou (CN)

(21) Appl. No.: 18/209,561

(22) Filed: Jun. 14, 2023

Related U.S. Application Data
(63) Continuation of application No. PCT/CN2021/100736, filed on Jun. 17, 2021.

(30) Foreign Application Priority Data
Dec. 14, 2020 (CN) 202011467224.5

(51) Int. Cl. B60W 40/13; B60W 50/14

(52) U.S. Cl. CPC B60W 40/13; B60W 50/14; B60W 2050/143

(57) ABSTRACT

Disclosed are a truck load identification method, an electronic device and a storage medium. The truck load identification method includes: obtaining a to-be-identified image; in response to a truck being identified in the to-be-identified image, identifying a plurality of key points of a cargo area of the truck in the to-be-identified image; obtaining a cargo area map including only the cargo area based on the plurality of key points; obtaining a cargo attribute of the cargo area by identifying the cargo area map; and in response to determining that a current state of the truck is a preset state based on the cargo attribute of the cargo area, conducting a warning prompt. By virtue of the truck load identification method provided by the present disclosure, the identification accuracy may be improved.

### CROSS REFERENCE

The present application is a continuation-application of International (PCT) Patent Application No. PCT/CN2021/100736, filed on Jun. 17, 2021, which claims priority of Chinese Patent Application No. 202011467224.5, filed on Dec. 14, 2020, the entire contents of which are hereby incorporated by reference in its entirety.

### TECHNICAL FIELD

The present disclosure relates to the field of image processing technologies, and in particular to a truck load identification method, an electronic device and a storage medium.

### BACKGROUND

With the rapid development of the national economy, increasingly busy traffic and increasingly fierce competition within the road-freight market, there may be some truck owners disregarding traffic safety and maliciously overloading. Under such environment, the order of the freight market is disrupted, and the structural safety as well as the service life of the highway are seriously threatened. Therefore, it is imperative to control the super-high loading of trucks from the technical level.

### SUMMARY OF THE DISCLOSURE

The main technical problem solved by the present disclosure is to provide a truck load identification method, an electronic device and a storage medium, thereby improving the identification accuracy.

To solve the above technical problem, a solution adopted by the present disclosure is to provide a truck load identification method including: obtaining a to-be-identified image; in response to a truck being identified in the to-be-identified image, identifying a plurality of key points of a cargo area of the truck in the to-be-identified image; obtaining a cargo area map including only the cargo area based on the plurality of key points; obtaining a cargo attribute of the cargo area by identifying the cargo area map; and in response to determining that a current state of the truck is a preset state based on the cargo attribute of the cargo area, conducting a warning prompt.

To solve the above technical problem, another solution adopted by the present disclosure is to provide an electronic device: including: a processor, a memory and a communication circuit; wherein the processor is respectively coupled to the memory and the communication circuit; during operation, the processor controls the processor itself, the memory, and the communication circuit to implement operations in the method as described above.

To solve the above technical problem, another solution adopted by the present disclosure is to provide a storage medium, storing a computer program, wherein the computer program is capable of being executed by a processor to implement operations in the method as described above.

Beneficial effects of the present disclosure is: A plurality of key points of a cargo area of a truck is firstly identified, and then a cargo area map that includes only the cargo area is obtained based on the plurality of key points. Since the cargo area map includes only the cargo area, invalid information around the truck is excluded and the interference of the invalid information is reduced. Therefore, when the current state of the truck is identified subsequently based on the cargo attribute of the cargo area, the identification accuracy may be improved.

### BRIEF DESCRIPTION OF THE DRAWINGS

In order to more clearly describe the technical solutions in the embodiments of the present disclosure, the following will briefly introduce the drawings required in the description of the embodiments. Obviously, the drawings in the following description are only some embodiments of the present disclosure. For a person skilled in the art, other drawings can be obtained based on these drawings without creative work.

FIG. 1 is a flowchart of a truck load identification method according to an embodiment of the present disclosure.

FIG. 2 is a structural schematic view of a to-be-identified image according to an embodiment of the present disclosure.

FIG. 3 is a structural schematic view of a to-be-identified image according to another embodiment of the present disclosure.

FIG. 4 is a structural schematic view of a to-be-identified image according to further another embodiment of the present disclosure.

FIG. 5 is a schematic view of a network structure of a neural network according to an embodiment of the present disclosure.

FIG. 6 is a flowchart of a training method of the neural network shown in FIG. 5.

FIG. 7 is a structural schematic view of an electronic device according to an embodiment of the present disclosure.

FIG. 8 is a structural schematic view of an electronic device according to another embodiment of the present disclosure.

FIG. 9 is a structural schematic view of a storage medium according to an embodiment of the present disclosure.

### DETAILED DESCRIPTION

The following will clearly and completely describe the technical solutions in the embodiments of the present disclosure in conjunction with the drawings in the embodiments of the present disclosure. Obviously, the described embodiments are only a part of the embodiments of the present disclosure, rather than all the embodiments. Based on the embodiments in the present disclosure, all other embodiments obtained by a person skilled in the art without creative work shall fall within the scope of the present disclosure.

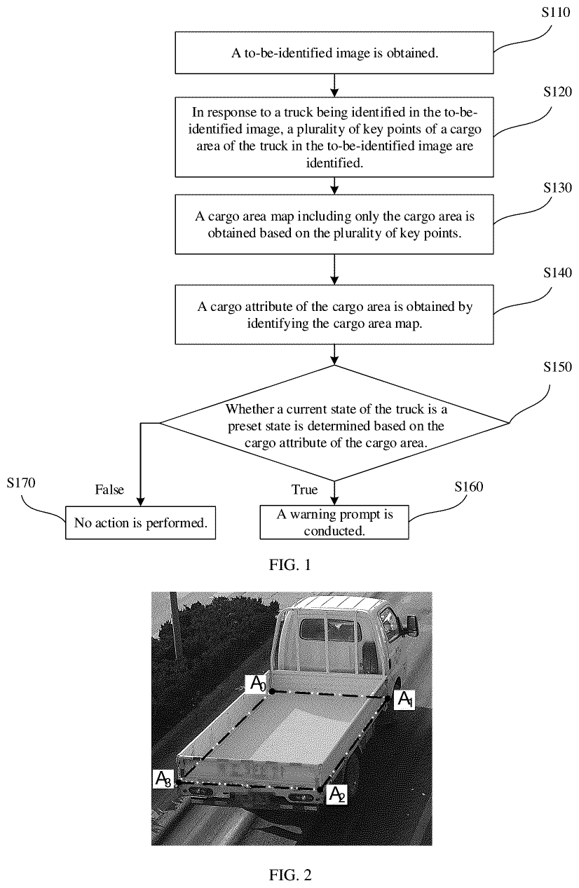

Referring to FIG. 1, FIG. 1 is a flowchart of a truck load identification method according to an embodiment of the present disclosure. The method includes operations at blocks illustrated in FIG. 1.

At block S110: A to-be-identified image is obtained.

Specifically, the to-be-identified image may be an image obtained by any means. The to-be-identified image may be any type of image such as a color image, a grayscale image, etc.

At block S120: In response to a truck being identified in the to-be-identified image, a plurality of key points of a cargo area of the truck in the to-be-identified image are identified.

Specifically, after the to-be-identified image is obtained, when the truck is identified in the to-be-identified image, the to-be-identified image is further identified to obtain the plurality of key points of the cargo area of the truck in the to-be-identified image (the cargo area is an area for the van to carry cargo). The plurality of key points constrain the cargo area of the van.

At block S130: A cargo area map including only the cargo area is obtained based on the plurality of key points.

Specifically, the cargo area map includes only the cargo area of the truck and does not include other areas.

At block S140: A cargo attribute of the cargo area is obtained by identifying the cargo area map.

Specifically, the cargo attribute of the cargo area may include a variety of possibilities. For example, the cargo attribute of the cargo area may include five kinds: Unloading, Striped texture, Regular block texture, Irregular block texture, and Other. The cargo attribute of the cargo area is Unloading, indicating that there is no cargo on the truck. The cargo attribute of the cargo area is Strip texture, indicating that the cargoes on the truck may be wood, pipes, and the like. The cargo attribute of the cargo area is a Regular block texture, indicating that the cargoes on the truck may be bricks and the like. The cargo attribute of the cargo area is Irregular block texture, indicating that the cargoes on the truck may be foam and the like. The cargo attribute of the cargo area is Other, indicating that the cargoes on the truck cannot be distinguished.

At block S150: Whether a current state of the truck is a preset state is determined based on the cargo attribute of the cargo area.

When the current state of the truck is the preset state, an operation S160 is performed. When the current state of the truck is not the preset state, an operation S170 is performed.

Specifically, when the current state of the truck is the preset state, it indicates that the truck may have security risks currently, and then the operation S160 is performed, otherwise the operation S170 is performed.

The preset state may be the truck being in an overload state, the cargoes on the truck being easy to fall off, and may also be the truck being in the overload state and the cargoes on the truck being easy to fall off.

At block S160: A warning prompt is conducted.

Specifically, the warning prompt may be in the form of an audible alarm alert and/or a lighted alarm alert light, etc., without any limitation in the present disclosure.

At block S170: No action is performed.

From the above, as can be seen in the present disclosure, a plurality of key points of a cargo area of a truck is firstly identified, and then a cargo area map that includes only the cargo area is obtained based on the plurality of key points. Since the cargo area map includes only the cargo area, invalid information around the truck is excluded and the interference of the invalid information is reduced. Therefore, when the current state of the truck is identified subsequently based on the cargo attribute of the cargo area, the identification accuracy may be improved.

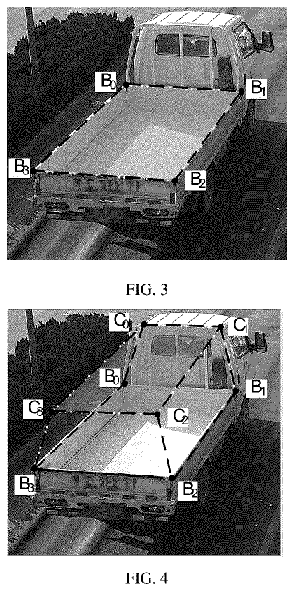

Combined with FIGS. 2 to 4, in the embodiments, the cargo area of the truck may include three level sub-areas, which are defined as a first-level sub-area, a second-level sub-area, and a third-level sub-area.

Specifically, the first-level sub-area is a quadrilateral defined by four geometric corner points (A₀-A₃) of a bottom surface of the actual cargo area of the truck, the second-level sub-area is a quadrilateral defined by four geometric corner points (B₀-B₃) of an upper boundary of a fence of the truck, and the third-level sub-area is a quadrilateral defined by four geometric corner points (C₀-C₃) of a top surface of the actual cargo area of the truck. C₀ and C₁ are two geometric corner points at a rear position of a roof of the truck (the rear position of the roof is near a driver seat). C₂ is obtained by translating the line segment C₁B₁ along the direction from B₁ to B₂. The distance between point C₁ and point C₂ is equal to the distance between point B₁ and point B₂. C₃ is obtained by translating the line segment C₀B₀ along the direction from B₀ to B₃. The distance between point C₀ and point C₃ is equal to the distance between point B₀ and point B₃.

In this case, in the operation S120, the 12 key points (A₀-A₃, B₀-B₃, C₀-C₃) at the cargo area are firstly identified; and then in the operation S130, a first-level sub-area map including only the first first-level sub-area, a second-level sub-area map including only the second-level sub-area, and a third-level sub-area map including only the third-level sub-area are obtained based on the 12 key points.

Then in the operation S140, the first-level sub-area map, the second-level sub-area map, and the third-level sub-area map are identified respectively to obtain the cargo attributes of the three level sub-areas. And then, the cargo attribute of the cargo area is obtained based on the prediction results of the three classification units 121. That is, the second loss function value is obtained based on the cargo attributes of the first-level sub-area map, the second-level sub-area map, and the third-level sub-area map. Specifically, corresponding to the five possibilities for the cargo attribute of the cargo area, there are also five possibilities for the cargo attribute of each level sub-area: Unloading, Striped texture, Regular block texture, Irregular block texture, and Other. After obtaining the cargo attributes of the three level sub-areas, the cargo attributes of the three level sub-areas may be combined to obtain the cargo attribute of the cargo area.

For example, when the cargo attribute of the first-level sub-area is Unloading, it can be determined that there is no cargo on the truck. When the cargo attribute of the third-level sub-area is non-empty (for example, Striped texture or Irregular block texture), it can be determined that the truck is over-high loaded, indicating that the truck is overloaded. When the cargo attributes of the first-level sub-area and the second-level sub-area are all Strip texture, it can be determined that the cargoes transported on the truck are wood, pipes, or other cargoes that have exceeded the fence, and there is a possibility of scattering. When the cargo attribute of the first-level sub-area is Irregular block texture, and when the cargo attribute of the second-level sub-area is Unloading, it can be determined that the cargo transported on the truck is foam-like cargo that does not exceed the fence, which belongs to the scope of safe transportation.

In the embodiments, in the operation S130, the obtaining the first-level sub-area map including only the first-level sub-area, the second-level sub-area map including only the second-level sub-area, and the third-level sub-area map are obtained based on the 12 key points may include:
(a) Generating a key point mask map for each of the key points.
(b) Obtaining a level sub-area mask map of a corresponding level sub-area by adding the key point mask maps of key points at the corresponding level sub-area.
(c) Generating a mask map matrix by: traversing all pixels in the level sub-area mask map, configuring pixels inside a largest circumscribed polygon connected by the key points to 1, and configuring pixels outside the largest circumscribed polygon connected by the key points to 0.
(d) Obtaining the level sub-area map by performing matrix point multiplication on: the to-be-identified image or a feature map of the to-be-identified image; and the mask map matrix.

Specifically, the 12 key point mask maps are generated corresponding to the 12 key points. Each key point mask map corresponds to a key point. In the key point mask map, the pixel value of a key point position is different from the pixel values of other positions. For example, the pixel value of the key point position is 1, and the pixel value of all other positions is 0. Then the key point mask maps corresponding to A₀-A₃ are added together to obtain the first-level sub-area mask map. The key point mask maps corresponding to B₀-B₃ are added together to obtain the second-level sub-area mask map. The key point mask maps corresponding to C₀-C₃ are added together to obtain the third-level sub-area mask map. Then all the pixels in the first-level sub-area mask map are traversed. Pixels inside the largest circumscribed polygon connected by A₀-A₃ are configured to 1, and pixels outside the largest circumscribed polygon connected by A₀-A₃ are configured to 0 to generate a first mask map matrix. Similarly, the same processing method is applied to the second-level sub-area mask map and the third-level sub-area to obtain a second mask map matrix and a third mask map matrix. Finally, the to-be-identified image/the feature map of the to-be-identified image are processed by matrix point multiplication with the first mask map matrix, the second mask map matrix or the third mask map matrix respectively to obtain the first-level sub-area map, the second-level sub-area map, and the third-level sub-area map.

The feature map of the to-be-identified image may be any image capable of characterizing the features of the to-be-identified image, such as a grayscale image, an edge detection image, etc. of the to-be-identified image, which is not limited here.

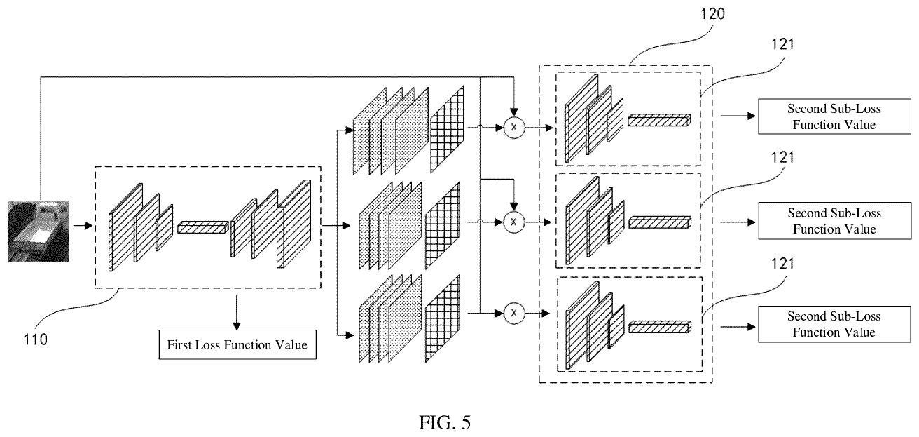

In the embodiments, further referring to FIG. 5, to improve the identification efficiency, the to-be-identified image may be identified through a first pre-trained first neural network. Specifically, the first neural network includes an identification module 110 and a classification module 120 connected in series. In the operation S120, the to-be-identified image is identified through the identification module 110 to obtain the plurality of key points of the cargo area of the truck. After the cargo area map including only the cargo area is obtained based on the plurality of key points in the operation S130, the cargo area map is identified through the classification module 120 to obtain the cargo attribute of the cargo area in the operation S140.

That is, after the to-be-identified image is input into the first neural network, the first neural network is able to directly output the cargo attribute of the cargo area of the truck.

When the cargo area includes the first-level sub-area, the second-level sub-area and the third-level sub-area, the classification module 120 includes three parallel connected classification units 121.

Specifically, after the identification module 110 outputs the 12 key points (A0-A3, B0-B3, C0-C3), and after the first-level sub-area map including only the first-level sub-area, the second-level sub-area map including only the second-level sub-area, and the third-level sub-area map including only the third-level sub-area are obtained based on the 12 key points in the operation S130, the first-level sub area map, the second-level sub-area map and the third-level sub-area map are input to the three classification units 121 in the operation S140 to identify the cargo attributes of the three level sub-areas through the three classification units 121 respectively, such that the first neural network finally outputs the cargo attributes of the three level sub-areas.

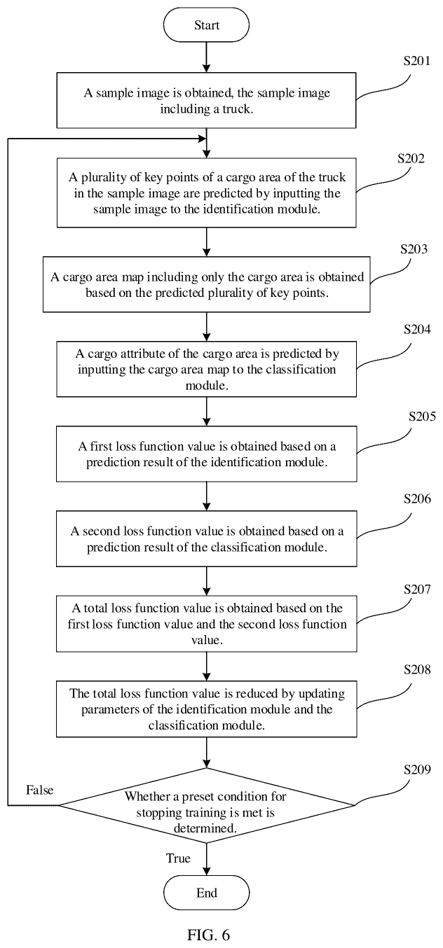

In the embodiments, further referring to FIG. 6, the first neutral network may be trained. A training method of the first neutral network may include operations at blocks illustrated in FIG. 6.

At block S201: A sample image is obtained, the sample image including a truck.

At block S202: A plurality of key points of a cargo area of the truck in the sample image are predicted by inputting the sample image to the identification module 110.

Specifically, combined with FIG. 5, after the basic framework of the first neutral network is constructed, the sample image is input to the identification module 110, and the identification module 110 predicts the plurality of key points at the cargo area. In a specific implementation, the identification module 110 may output predicted coordinates of the key points.

At block S203: A cargo area map including only the cargo area is obtained based on the predicted plurality of key points.

Specifically, this operation is the same or similar to the operation S130 above, reference may be made above and will not be repeated herein.

At block S204: A cargo attribute of the cargo area is predicted by inputting the cargo area map to the classification module 120.

Specifically, after the cargo area map is obtained in the operation S203, the cargo area map is input to the identification module 120 to predict the cargo attribute of the cargo area.

At block S205: A first loss function value is obtained based on a prediction result of the identification module 110.

Specifically, after the identification module 110 outputs the predicted coordinates of the plurality of key points, the first loss function value is obtained based on the predicted coordinates of the plurality of key points and actual coordinates of the plurality of key points.

At block S206: A second loss function value is obtained based on a prediction result of the classification module 120.

Specifically, after the classification module 120 outputs the predicted cargo attribute of the cargo area, the second loss function value is obtained based on the predicted cargo attribute of the cargo area and an actual cargo attribute of the cargo area.

At block S207: A total loss function value is obtained based on the first loss function value and the second loss function value.

Specifically, the obtained total loss function value may simultaneously represent a degree of convergence of the identification model 110 and the classification model 120 in the training process, and also represent a degree of training of the identification model 110 and the classification model 120.

The first loss function value is calculated based on a first loss function, and the second loss function is calculated based on a second loss function.

In some embodiments, the first loss function may be any function suitable for detecting task loss, such as IoU, GIoU, DIoU, CIoU, etc. The second loss function may be any function suitable for classifying task loss, such as LabelSmooth, AmSoftmax, etc.

As an example, the first loss function may be a mean-square-error loss function, and the second loss function may be a cross-entropy loss function.

In other embodiments, the first loss function may be a cross-entropy loss function, and the second loss function may be a mean-square-error loss function. Or, both the first loss function and the second loss function may be cross-entropy functions. Or, both the first loss function and the second loss function may be mean-square-error loss functions.

In some embodiments, the operation S207 may specifically include: obtaining the total loss function value by weighted summing the first loss function value and the second loss function value. The weight of the first loss function value and the weight of the second loss function value may be set based on configuration from a designer according to actual needs.

In other embodiments, the total loss function value may be obtained by another operation on the first loss function value and the second loss function value. For example, the first loss function value and the second loss function value may be multiplied to obtain the total loss function value. In short, the present disclosure does not limit how to obtain the total loss function value through the first loss function value and the second loss function value.

At block S208: The total loss function value is reduced by updating parameters of the identification module 110 and the classification module 120.

Specifically, the total loss function value may be gradually reduced to make the identification model 110 and the classification model 120 both converge, and finally make the neural network converge.

At block S209: Whether a preset condition for stopping training is met is determined.

In response to the preset condition being met, the training process ends. In response to the preset condition being not met, the training process is returned to the operation S202, that is, the above process is repeated until the preset condition for stopping training is met.

In the training method, the total loss function value is obtained based on the first loss function value and the second loss function value. In this way, during the training process, the identification module and the classification module of the neural network influence each other and “complement each other's strengths” to achieve an optimum balance, thereby improving the identification accuracy of the final trained neural network.

When the cargo area of the truck includes the first-level sub-area, the second-level sub-area and the third-level sub-area, and the classification module 120 includes the three classification units 121, then the operation S203 includes: obtaining a first-level sub-area map including only the first-level sub-area, a second-level sub-area map including only the second-level sub-area and a third-level sub-area map including only the third-level sub-area based on the predicted 12 key points (A0-A3, B0-B3, C0-C3). The process of obtaining the level sub-area map based on the key points is the same as the above process, and is not repeated here.

The operation S204 may include: predicting the cargo attributes of the three level sub-areas by inputting the three level sub-area maps to the three classification units 121

The operation S206 may include: obtaining the second loss function value based on the predicted results of the three classification units 121. That is, the second loss function value is obtained based on the predicted cargo attributes and the actual cargo attributes of the three level sub-areas.

In some embodiments, the obtaining the second loss function value based on the prediction results of the three classification units 121 may include: obtaining three second sub-loss function values based on the prediction results of the three classification units 121; obtaining the second loss function value by weighting and summing the three second sub-loss function values.

Specifically, each second sub-loss function value is firstly obtained based on the predicted cargo attribute and the actual cargo attribute of a corresponding level sub-area. That is, the three classification units 121 correspond to the three second sub-loss function values. Then the three second sub-loss function values are weighted and summed to obtain the second loss function value. In this case, when the three second sub-loss function values are weighted and summed, the weights of the three second sub-loss function values can be set based on the configuration from the designer according to needs of the actual situation.

In other embodiments, after the three second sub-loss function values are obtained, the second loss function value may be obtained by performing other operations such as multiplication of the three second sub-loss function values.

In other embodiments, after the three second sub-loss function values are obtained, the three second sub-loss function values may be combined with the first loss function value to obtain three total loss function values by, for example, a weighted sum operation, and then the parameters of the identification module 110 and the three classification units 121 may be updated to reduce the three total loss function values.

In the embodiments, to improve the efficiency of determining whether there is a truck in the to-be-identified image, a pre-trained second neural network may be applied to identify a type of a vehicle in the to-be-identified image before the operation S120.

Specifically, the second neural network is pre-trained to be able to determine whether there is a truck in the to-be-identified image. The first neural network includes but is not limited to SSD, Yolo, FasterRCNN, CenterNet, FCOS, etc., and the backbone network may be ResNet, Inception, DenseNet, MobileNe, etc., which is not limited in the present disclosure.

In some embodiments, the second neural network may identify the type of all vehicles in the to-be-identified image. In other embodiments, the second neural network may only identify trucks in the to-be-identified image, while other types of vehicles such as cars cannot be identified.

In the embodiments, the training method of the second neural network includes: obtaining a plurality of sample images, wherein each sample image includes a vehicle; obtaining label information of the each sample image, wherein the label information includes a position of the vehicle and the type of the vehicle; configuring the each sample image as an input, and training the second neural network with the label information as a truth label.

Specifically, the position of the vehicle may be the position of a certain point on the vehicle, such as the center point, in the entire sample image

By training the second neural network in the above method, the trained second neural network can not only identify the truck in the to-be-identified image, but also determine the position of the truck in the to-be-identified image. In this way, when there is more than one vehicle in the to-be-identified image, a truck image may be extracted, and the truck image includes only one truck. Subsequent operations may be performed based on the truck image to simplify the steps and improve the accuracy.

It is to be noted that the foregoing description of the solutions of the present disclosure is described with the cargo area including the three level sub-areas, but the present disclosure is not limited to this. In other embodiments, the cargo area may include one, four, five or more level sub-areas.

Correspondingly, the number of classification units 121 may also be one, four, five or more, as long as the number of classification units 121 is equal to the number of the level sub-areas. For example, the cargo area may only include the third-level sub-areas, and the number of classification units 121 is also one. In this case, the finally trained neural network may be configured to determine whether the truck is overloaded.

The present disclosure does not limit the constraints of the level sub-areas at the cargo area. For example, as shown in FIG. 4, a level sub-area may also be a quadrilateral area defined by C₃, C₂, B₂, and B₃ (defined as a fourth-level sub-area), or a quadrilateral area defined by C₁, C₂, B₂, and B₁ (defined as a fifth-level sub-area), or a quadrilateral area defined by C₀, C₃, B₃, and B₀ (defined as a sixth level sub-area). It can be understood that the finally method in this case may help identify whether the truck is over-wide and over-long loaded when transporting cargoes. For example, when the neural network identifies that the cargo attribute of the fourth-level sub-area is not empty, it is determined that the truck is over-long loaded, indicating that the truck is overload. When the neural network identifies that the cargo attribute of the fifth-level sub-area or the sixth-level sub-area is not empty, it is determined that the truck is over-wide loaded, indicating that the truck is overload.

The key points corresponding to each level sub-area may not be four, but may be five, eight or more, and the present disclosure is not limited.

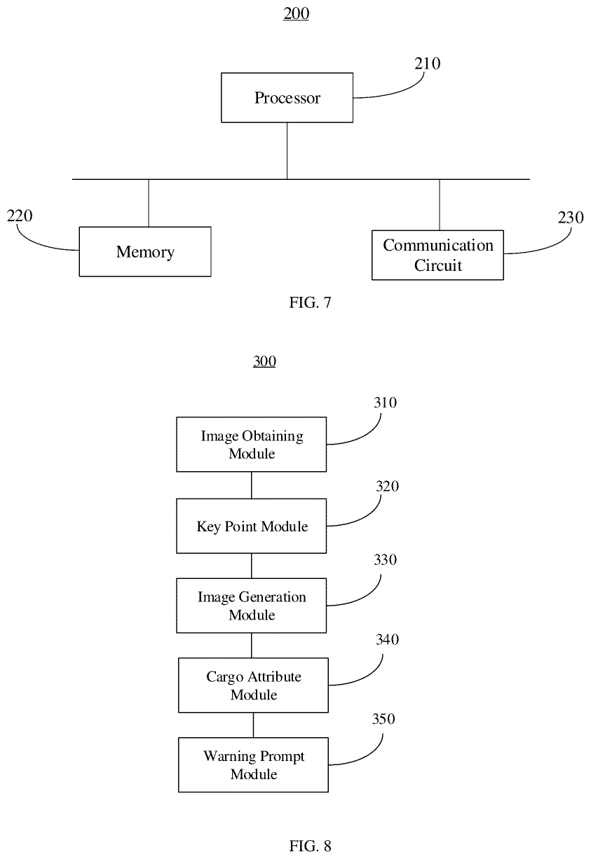

Referring to FIG. 7, FIG. 7 is a structural schematic view of an electronic device according to an embodiment of the present disclosure. The electronic device 200 includes a processor 210, a memory 220, and a communication circuit 230. The processor 210 is respectively coupled to the memory 220 and the communication circuit 230. During operation, the processor 210 controls itself, the memory 220, and the communication circuit 230 to implement the operations in any one of the above methods. For the detailed operations, reference may be made to the above-mentioned embodiments, which will not be repeated here.

The electronic device 200 may be any device with information processing capabilities, such as a mobile phone, a computer, etc., which is not limited here.

Referring to FIG. 8, FIG. 8 is a structural schematic view of an electronic device according to another embodiment of the present disclosure. The electronic device 300 includes an image obtaining module 310, a key point module 320, an image generation module 330, a cargo attribute module 340, and a warning prompt module 350.

The image obtaining module 310 is configured to obtain a to-be-identified image.

The key point module 320 is connected to the image obtaining module 310 and configured to, in response to a truck being identified in the to-be-identified image, identifying a plurality of key points of a cargo area of the truck in the to-be-identified image.

The image generation module 330 is connected to the key point module 320 and configured to obtain a cargo area map including only the cargo area based on the plurality of key points.

The cargo attribute module 340 is connected to the image generation module 330 and configured to identify the cargo area map to obtain a cargo attribute of the cargo area.

The warning prompt module 350 is configured to, in response to a current state of the truck being determined to be a preset state based on the cargo attribute of the cargo area, conduct a warning prompt.

In some embodiments, the cargo area of the truck may include a plurality of level sub-areas, and the cargo area map may include a plurality of level sub-area maps. The image generation module 330 is specifically configured to obtain the plurality of level sub-area maps that each includes only one level sub-area based on the plurality of key points.

In some embodiments, the cargo attribute module 340 is specifically configured to separately identify the plurality of level sub-area maps to obtain cargo attributes of the plurality of level sub-areas; and to obtain cargo attribute of the cargo area based on the cargo attributes of the plurality of level sub-areas.

In some embodiments, the image generation module 330 is specifically configured to generate a key point mask map for each of the key points; obtain a level sub-area mask map of a corresponding level sub-area by adding the key point mask maps of key points at the corresponding level sub-area; generate a mask map matrix by: traversing all pixels in the level sub-area mask map, configuring pixels inside a largest circumscribed polygon connected by the key points to 1, and configuring pixels outside the largest circumscribed polygon connected by the key points to 0; and obtain the level sub-area map by performing matrix point multiplication on: the to-be-identified image or a feature map of the to-be-identified image; and the mask map matrix.

In some embodiments, the plurality of level sub-areas may include at least a first-level sub-area, a second-level sub-area, and a third-level sub-area. The first-level sub-area is defined by geometric corner points of a bottom surface of the actual cargo area of the truck, the second-level sub-area is defined by geometric corner points of an upper boundary of a fence of the truck, and the third-level sub-area is defined by geometric corner points of a top surface of the actual cargo area of the truck.

In some embodiments, the key point module 320 is specifically configured to identify the to-be-identified image through the identification module in the first neural network to obtain the plurality of key points of the cargo area of the truck. The cargo attribute module 340 is specifically configured to identify the cargo area map through the classification module in the first neural network in series with the identification module to obtain the cargo attribute of the cargo area.

In some embodiments, the electronic device 400 further includes a network training module for obtaining a sample image, wherein the sample image includes a truck; predicting a plurality of key points of a cargo area of the truck in the sample image by inputting the sample image to the identification module; obtaining a cargo area map including only the cargo area based on the predicted plurality of key points; predicting a cargo attribute of the cargo area by inputting the cargo area map to the classification module; obtaining a first loss function value based on a prediction result of the identification module; obtaining a second loss function value based on a prediction result of the classification module; obtaining a total loss function value based on the first loss function value and the second loss function value; reducing the total loss function value by updating parameters of the identification module and the classification module; and repeatedly performing operations from the inputting the sample image to the identification module to the reducing the total loss function value by updating parameters of the identification module and the classification module, until a preset condition for stopping training is met.

In some embodiments, the cargo area includes a plurality of level sub-areas, and the classification module includes a plurality of parallel classification units with the same number as the number of the level sub-areas. The training module is specifically configured to obtain a plurality of level sub-area maps each of which includes only one level sub-area based on the predicted plurality of key points; input the plurality of level sub-area maps to the plurality of classification units respectively to predict cargo attributes of the level sub-areas; and obtain the second loss function value based on the prediction results of the plurality of classification units.

In some embodiments, the training module is specifically configured to obtain a plurality of second sub-loss function values based on the prediction results of the plurality of classification units, and obtain the second loss function value by performing a weighted summation on the plurality of second sub-loss function values.

In some embodiments, the training module is specifically configured to obtain the total loss function value by weighted summing the first loss function value and the second loss function value.

The electronic device 300 may be any device with information processing capabilities, such as a mobile phone, a computer, etc., which is not limited here.

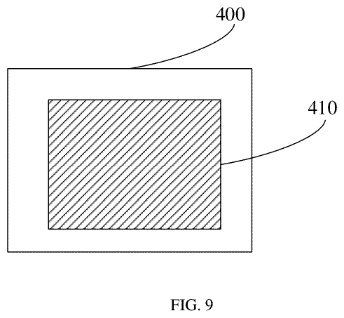

Refer to FIG. 9, FIG. 9 is a structural schematic view of a storage medium according to an embodiment of the present disclosure. The storage medium 400 stores a computer program 410, and the computer program 410 can be executed by a processor to implement the operations in any of the foregoing methods.

The storage medium 400 may specifically be a U disk, a mobile hard disk, a read-only memory (ROM,), a random access memory (RAM), a magnetic disk or an optical disk and other devices that can store the computer program 510. Alternatively, it may also be a server storing the computer program 510. The server may send the stored computer program 510 to other devices to execute, or execute the stored computer program 510 by itself.

The above description is only an implementation of the present disclosure, and is not intended to limit the scope of the present disclosure. Any equivalent structure or equivalent process transformation using the contents of the specification and the accompanying drawings, or direct or indirect application in other related technical fields, is included in the scope of the present disclosure.

What is claimed is:

1. A truck load identification method, comprising:
obtaining a to-be-identified image;
in response to a truck being identified in the to-be-identified image, identifying a plurality of key points of a cargo area of the truck in the to-be-identified image;
obtaining a cargo area map comprising only the cargo area based on the plurality of key points;
obtaining a cargo attribute of the cargo area by identifying the cargo area map; and
in response to determining that a current state of the truck is a preset state based on the cargo attribute of the cargo area, conducting a warning prompt.

2. The method according to claim 1, wherein the cargo area comprises a plurality of level sub-areas, and the cargo area map comprises a plurality of level sub-area maps;
the obtaining the cargo area map comprising only the cargo area based on the plurality of key points comprises:
obtaining the plurality of level sub-area maps each of which comprises only one corresponding level sub-area based on the plurality of key points.

3. The method according to claim 2, wherein obtaining the cargo attribute of the cargo area by identifying the cargo area map comprises:
obtaining cargo attributes of the plurality of level sub-areas by identifying each of the plurality of level sub-area maps;
obtaining the cargo attribute of the cargo area based on the cargo attributes of the plurality of level sub-areas.

4. The method according to claim 2, wherein the obtaining the plurality of level sub-area maps each of which comprises only one corresponding level sub-area based on the plurality of key points comprises:
generating a key point mask map for each of the plurality of key points;
obtaining a level sub-area mask map of a corresponding level sub-area by adding the key point mask maps of key points at the corresponding level sub-area;
generating a mask map matrix by:
traversing all pixels in the level sub-area mask map,
configuring pixels inside a largest circumscribed polygon connected by the key points to 1; and
configuring pixels outside the largest circumscribed polygon connected by the key points to 0; and
obtaining the level sub-area map by performing matrix point multiplication on:
the to-be-identified image or a feature map of the to-be-identified image; and
the mask map matrix.

5. The method according to claim 2, wherein the plurality of level sub-areas comprise at least a first-level sub-area, a second-level sub-area, and a third-level sub-area; the first-level sub-area is defined by geometric corner points of a bottom surface of an actual cargo area of the truck; the second-level sub-area is defined by geometric corner points of an upper boundary of a fence of the truck; the third-level sub-area is defined by geometric corner points of a top surface of the actual cargo area of the truck.

6. The method according to claim 1, wherein identifying the plurality of key points of the cargo area of the truck in the to-be-identified image comprises:
obtaining the plurality of key points of the cargo area of the truck by identifying the to-be-identified image through an identification module of a first neural network;
the obtaining the cargo attribute of the cargo area by identifying the cargo area map comprises:
obtaining the cargo attribute of the cargo area by identifying the cargo area map through a classification module of the first neural network connected in series with the identification module.

7. The method according to claim 6, further comprising:
obtaining a sample image, wherein the sample image comprises a truck;
predicting a plurality of key points of a cargo area of the truck in the sample image by inputting the sample image to the identification module;
obtaining a cargo area map comprising only the cargo area based on the predicted plurality of key points;
predicting a cargo attribute of the cargo area by inputting the cargo area map to the classification module;
obtaining a first loss function value based on a prediction result of the identification module;
obtaining a second loss function value based on a prediction result of the classification module;
obtaining a total loss function value based on the first loss function value and the second loss function value;
reducing the total loss function value by updating parameters of the identification module and the classification module; and
repeatedly performing operations from the predicting the plurality of key points of the cargo area of the truck in the sample image by inputting the sample image to the identification module to the reducing the total loss function value by updating parameters of the identification module and the classification module, until a preset condition for stopping training is met.

8. The method according to claim 7, wherein the cargo area comprises a plurality of level sub-areas, and the classification module comprises a plurality of classification units connected in parallel; the number of the plurality of classification units is the same as the number of the plurality of level sub-areas;
the obtaining the cargo area map comprising only the cargo area based on the predicted plurality of key points comprises:
obtaining the plurality of level sub-area maps each of which comprises only one level sub-area based on the predicted plurality of key points;
the predicting the cargo attribute of the cargo area by inputting the cargo area map to the classification module comprises:
inputting the plurality of level sub-area maps to the plurality of classification units respectively to predict cargo attributes of the level sub-areas;
obtaining the second loss function value based on the prediction result of the classification module comprises:
obtaining the second loss function value based on prediction results of the plurality of classification units.

9. The method according to claim 8, wherein the obtaining the second loss function value based on the prediction results of the plurality of classification units comprises:
obtaining a plurality of second sub-loss function values based on the prediction results of the plurality of classification units; and
obtaining the second loss function value by performing a weighted summation on the plurality of second sub-loss function values.

10. The method according to claim 7, wherein the obtaining the total loss function value based on the first loss function value and the second loss function value comprises:
obtaining the total loss function value by weighted summing the first loss function value and the second loss function value.

11. An electronic device, comprising: a processor, a memory and a communication circuit; wherein the processor is respectively coupled to the memory and the communication circuit; during operation, the processor controls the processor itself, the memory, and the communication circuit to implement:
obtaining a to-be-identified image;
in response to a truck being identified in the to-be-identified image, identifying a plurality of key points of a cargo area of the truck in the to-be-identified image;
obtaining a cargo area map comprising only the cargo area based on the plurality of key points;
obtaining a cargo attribute of the cargo area by identifying the cargo area map; and
in response to determining that a current state of the truck is a preset state based on the cargo attribute of the cargo area, conducting a warning prompt.

12. The electronic device according to claim 11, wherein the cargo area comprises a plurality of level sub-areas, and the cargo area map comprises a plurality of level sub-area maps;
the obtaining the cargo area map comprising only the cargo area based on the plurality of key points comprises:
obtaining the plurality of level sub-area maps each of which comprises only one corresponding level sub-area based on the plurality of key points.

13. The electronic device according to claim 12, wherein obtaining the cargo attribute of the cargo area by identifying the cargo area map comprises:
obtaining cargo attributes of the plurality of level sub-areas by identifying each of the plurality of level sub-area maps;
obtaining the cargo attribute of the cargo area based on the cargo attributes of the plurality of level sub-areas.

14. The electronic device according to claim 12, wherein the obtaining the plurality of level sub-area maps each of which comprises only one corresponding level sub-area based on the plurality of key points comprises:
generating a key point mask map for each of the plurality of key points;
obtaining a level sub-area mask map of a corresponding level sub-area by adding the key point mask maps of key points at the corresponding level sub-area;
generating a mask map matrix by:
traversing all pixels in the level sub-area mask map,
configuring pixels inside a largest circumscribed polygon connected by the key points to 1; and
configuring pixels outside the largest circumscribed polygon connected by the key points to 0; and
obtaining the level sub-area map by performing matrix point multiplication on:
the to-be-identified image or a feature map of the to-be-identified image; and
the mask map matrix.

15. The electronic device according to claim 12, wherein the plurality of level sub-areas comprise at least a first-level sub-area, a second-level sub-area, and a third-level sub-area; the first-level sub-area is defined by geometric corner points of a bottom surface of an actual cargo area of the truck; the second-level sub-area is defined by geometric corner points of an upper boundary of a fence of the truck; the third-level sub-area is defined by geometric corner points of a top surface of the actual cargo area of the truck.

16. The electronic device according to claim 11, wherein identifying the plurality of key points of the cargo area of the truck in the to-be-identified image comprises:
obtaining the plurality of key points of the cargo area of the truck by identifying the to-be-identified image through an identification module of a first neural network;
the obtaining the cargo attribute of the cargo area by identifying the cargo area map comprises:
obtaining the cargo attribute of the cargo area by identifying the cargo area map through a classification module of the first neural network connected in series with the identification module.

17. The electronic according to claim 16, wherein during operation, the processor controls the processor itself, the memory, and the communication circuit to further implement:
obtaining a sample image, wherein the sample image comprises a truck;
predicting a plurality of key points of a cargo area of the truck in the sample image by inputting the sample image to the identification module;
obtaining a cargo area map comprising only the cargo area based on the predicted plurality of key points;
predicting a cargo attribute of the cargo area by inputting the cargo area map to the classification module;
obtaining a first loss function value based on a prediction result of the identification module;
obtaining a second loss function value based on a prediction result of the classification module;
obtaining a total loss function value based on the first loss function value and the second loss function value;
reducing the total loss function value by updating parameters of the identification module and the classification module; and
repeatedly performing operations from the predicting the plurality of key points of the cargo area of the truck in the sample image by inputting the sample image to the identification module to the reducing the total loss function value by updating parameters of the identification module and the classification module, until a preset condition for stopping training is met.

18. The electronic according to claim 17, wherein the cargo area comprises a plurality of level sub-areas, and the classification module comprises a plurality of classification units connected in parallel; the number of the plurality of classification units is the same as the number of the plurality of level sub-areas;
the obtaining the cargo area map comprising only the cargo area based on the predicted plurality of key points comprises:
obtaining the plurality of level sub-area maps each of which comprises only one level sub-area based on the predicted plurality of key points;
the predicting the cargo attribute of the cargo area by inputting the cargo area map to the classification module comprises:
inputting the plurality of level sub-area maps to the plurality of classification units respectively to predict cargo attributes of the level sub-areas;
obtaining the second loss function value based on the prediction result of the classification module comprises:
obtaining the second loss function value based on prediction results of the plurality of classification units.

19. The electronic according to claim 18, wherein the obtaining the second loss function value based on the prediction results of the plurality of classification units comprises:
obtaining a plurality of second sub-loss function values based on the prediction results of the plurality of classification units; and
obtaining the second loss function value by performing a weighted summation on the plurality of second sub-loss function values.

20. A non-transitory computer-readable storage medium, storing a computer program, wherein the computer program is capable of being executed by a processor to implement:
obtaining a to-be-identified image;
in response to a truck being identified in the to-be-identified image, identifying a plurality of key points of a cargo area of the truck in the to-be-identified image;
obtaining a cargo area map comprising only the cargo area based on the plurality of key points;
obtaining a cargo attribute of the cargo area by identifying the cargo area map; and
in response to determining that a current state of the truck is a preset state based on the cargo attribute of the cargo area, conducting a warning prompt.
